(19) United States
(12) Patent Application Publication
(10) Pub. No.: US 2002/0046036 A1
(43) Pub. Date: Apr. 18, 2002

(54) Business work administration support system

(76) Inventor: Katsuaki Kobayashi, Yokohama-shi (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/725,961

(22) Filed: Nov. 30, 2000

(30) Foreign Application Priority Data
Feb. 29, 2000 (JP) 2000-054630
Feb. 29, 2000 (JP) 2000-054631
Feb. 29, 2000 (JP) 2000-054632

(51) Int. Cl. G06F 17/60

(52) U.S. Cl. 705/1

(57) ABSTRACT

It is to provide a business work administration support system which is able to support users A, B, C and D by doing the all or part of their works as utilizing a web hosting. As a method to provide the above, the business work administration support system comprises a client machine 1 and a main server S; and these are connected by a communication network 5. The main server S stores data necessary for business work processing sent from the client machine 1 and also contains programs for business work processing that are made to execute the business work processing. The client machine 1 has a browser that can display the process and result of the business work processing. Through the browser, the users A, B, C and D can observe the results of business work processing done by the main server S. The programs for business work processing are prepared by an architecture neutral language. Moreover, the client machine 1 and the main server S are designed to support to the program language.

### BACKGROUND OF THE INVENTION

1. Field of the Invention

The present invention relates to a business work administration support system designed to support the all or a part of works that the users ought to do by utilizing a web hosting service, or a business work administration support system designed to provide a client machine with processing programs for business works in the form of a plurality of components desirably as necessitated by the users to execute their business works.

2. Related Art

A considerable large amount of works as well as considerable deep knowledge on accounting and the like are required for many types of companies to prepare their accurate business documents, such as a final account statement and others to declare a final return for the year. Therefore, more numbers of the those companies are to enter into contracts with accounting specialists in counting houses and the like to entrust the specialists with the account processing works, for example, to prepare the final account statement and so on.

The above specialists entrusted to perform the account processing works have conventionally employed a system, in which the specialists receive account books and other documents holding data required for account processing in the form of cashbooks and the like from the companies and then to execute various kinds of account processing works over the data by manpower. However, in such system, there are chances of accidents, such as loosing the cashbooks and so on because the cashbooks and other documents must be given and received between the companies and the specialists. Moreover, in cases with large scale companies who need to deliver a lot of data, a considerable large amount of works is required for giving and receiving the data as well as for account processing, although such works would not be a major problem with small scale companies, because the works are done by manpower even though calculators and other apparatus are being used. On the other hand, for the companies entrusting the account processing to the specialists have to pay more expensive fees for accounting services, since the specialists process the account data by manpower.

In order to overcome the above mentioned inconveniences, account processing systems utilizing computer systems have been developed and, in fact, such systems are being utilized. A conventional account processing system utilizing such computer system is comprising a large computer (main frame) storing account processing programs and a terminal (small computer) connected to the main frame through an ordinary public communication circuit or the like. The main frame is installed in a counting house and the like, and the small computer used as a terminal is installed in a office of company who is entrusting its account processing works to the counting house and the like.

In case of the conventional account processing system using the computer system composed as described above, data needed for account processing is sent to the main frame from the terminal (small computer) installed in the office of company through the ordinary public communication circuit and the like. The main frame stores the sent data by a memory means, and applies various kinds of account processing works based on the above data.

In the conventional account processing system using the computer system, the aforementioned data concerning revenue, expenditure and the like is no longer necessary to be given and received directly, and moreover, since the main frame performs complicated calculations and other works, the labors can be reduced and accidents such as loosing cashbooks and the like can be prevented as well. However, in the case of such system, it is required to employ a main frame having a large size and high performance. Accordingly, a wide space as well as a lot of costs are required for the installation. As a result, due to the wide space and high costs for installation, small scale counting houses and the like have had difficulties to employ such system.

In view of the above mentioned situation, an account processing system as shown in FIG. 3 has been conceived in accordance with the progress of computer systems in these years and in fact such system is being utilized. An account processing system shown in FIG. 3 utilizes a network system comprising a server machine 10 installed in an office of a specialist, such as a counting house and the like, and a client machine (small computer) 11 installed in an office of a company (hereinafter called a “user”) who is entrusting its account processing works to the specialist. The server machine 10 and the client machine 11 are connected through a network 12, such as ISDN (Integrated Services Digital Network).

The server machine 10 is loaded with functions for providing various controls related to the client machine 11, executing account processing, and working as a database server. Moreover, the client machine 11 is installed with an account processing program that subordinates to the accounting program loaded (installed) on the server machine 10. Based on the data processed by the program in the client machine 11, the final account processing shall be executed by the program installed in said server machine 10 as well as the data saved in the same server machine 10.

In case of the above mentioned system shown in FIG. 3, since small computers can be used for both of the server machine 10 and the client machine 11, the installation space and installation cost can be reduced. As a result, there is an advantage as it is easier for both the companies and specialists to employ such account processing system.

However, in case of the account processing system as described above, both the server machine 10 and the client machine 11 are needed to have various kinds of programs related to the account processing. Thus the memory capacities of hard disks (HD) and the like must be expanded, and thereof an extra cost is required for that. Moreover, among various programs related to the aforementioned account processing, there is a portion common to some of them. However, the common portion is to be included in each of those programs installed when the client machine 11 is installed with the various programs related to account processing works. In other words, a memory device of the client machine 11 is to store the plurality of common portions. In case that various programs are installed in the client machine 11, a large amount of memory is consumed and therefore it is necessary to expand the memory capacity of hard disk (HD) and the like for this reason and thereby an extra cost is required as a result.

Furthermore, because both of the server machine 10 and client machine 11 are to be installed with various programs related to account processing, works to maintain and manage the programs are required for both of the machines 10 and 11. For example, in cases that the account processing programs are renewed to upper versions due to debugging the programs, changes in tax ratio by amendments of laws and so on, the upper version programs for account processing have to be loaded (installed) into both of machines 10 and 11. Since such maintenance and operation works have to be done by an expert operator, the cost for maintenance and operation would increase as a result.

Moreover, in case that a machine type (OS) of client machine 11 is changed by reason of introduction of a new client machine or a like reason, programs suitable to the new machine have to be prepared. That is, in an example shown in FIG. 3, while a user A is equipped with a Windows machine, a user B is with a Mackintosh machine and a user C is with a Linux machine, programs loaded in the client machines 11 are different (not interchangeable). Therefore, software houses have to make programs suitable each of client machines 11. Each of users A, B, C and D has to employ an expert operator who has a good knowledge about operation of programs made suitable to OS and other conditions associated with each of client machines. Since the aforementioned account processing system is dependent on machine types as described above, a lager amount of labor and cost are required for maintenance and operation.

Moreover, in accordance with the progress of communication technologies in which the internet is the most noticeable example, such business activities as selling and buying between many nations have become easier. Therefore, it has become necessary to produce documents, such as various types of bills, in a currency used by each of concerning nations as well as in a format set by each nation or a format set by the international standards. However, in the conventional account processing system, software is made to meet with a particular nation, that is, the software (program) being used is limited to a currency of the nation and bill formats determined by the nation and therefore software (program) which can offer services for different currencies and bill types of various nations has not been known. Many kinds of inconveniences as described above are not only particular problems of works relating to the account processing, but also are seen in many different types of business processing systems using computer systems in a variety of business, such as distribution of stocked products and jobs related to credit and debt. Thus, it is required or expected to develop a business work administration support system which is independent from machine types, requires no any expert operators, be able to reduce the labor and cost for maintenance and operation and always performs the latest business processing works. In addition, users has been also waiting for system which can meet with international uses.

### SUMMARY OF THE INVENTION

The present invention related to a business work administration support system has been conceived as taking the above situation in consideration.

In the business work administration support systems related to this invention, there are provided at least one client machine and at least one main server, and these are connected each other by a communication network, thereby it can process the all or a part of works of a user who owns the client machine.

In the business work administration support system, the main server can readily store data sent through the client machine, needed for business work processing and is also loaded with programs for business works for performing the business work processing. The client machine is also equipped with a browser to display the business work processing and the obtained work results. Moreover, the program for business works installed in the main server is prepared in an architecture neutral program language. Then, the client machine and business work processing server are designed to support the aforementioned program language.

When various types of business works, such as account processing, are to be executed with the above business work administration support system, the client machine installed in a business office firstly sends the main server a command to perform the business work processing together with data needed to perform the business work processing required by the user. This procedure makes the main server to proceed business work processing required by the user.

The program for business works is prepared in an architecture neutral program language. Then, the main server and client machine are designed to support the aforementioned program language. Furthermore, the client machine is also equipped with a browser to display the business work processing and the obtained work results. As a result, the client machine can display a course of business work processing as well as the work results, as being regardless of OS and others.

That is to say, the system related to the present invention is not depending on machine types, so that no expert operators are need on the client side. Thus, the cost for maintenance and operation can be reduced. Moreover, when the programs for business works are required to be renewed to upper versions and so on, the changes have to be made only with the main server, so that the labor and cost for maintenance and operation on the user side would be little. Therefore, the labor and cost for maintenance and operation on the user side can be reduced, although the user can make the main server to do the all or a part of its works, as utilizing the latest program for business works.

In one aspect of the business work administration support system of the present invention, there are proveded at least one client machine and at least one main server which stores necessary data for various types of business work processing as well as contains components constituting programs for business works to execute various types of business work processing, and these are connected each other by a communication network. Further, it is able to desirably provide the client machine with components necessary to execute business work processing as per request by a user who owns the client machine.

In case of this business work administration support system, the programs for business works stored in the main server are prepared by an architecture neutral program language. Further, the client machine and business work processing server are designed to support the aforementioned program language.

When various types of business works, such as account processing, are executed with the business work administration support system having the aforementioned composition, the client machine at the user side downloads necessary components out of the programs for business works stored in the main server as per request by the user to execute his/her business work processing. By doing so, the business work processing can be executed at the client machine side.

In the case, the programs for business works are stored in the main server component by component so that the user can download necessary components and combine these components in use. Therefore, it can prevent to waste memory areas of memory unit, such as hard disk, of the client side.

Furthermore, these components (programs for business works) are prepared in the architecture neutral program language. The main server and client machine are designed to support the aforementioned program language. As a result, the client machine can readily download components (comprising programs for business works) from the main server and use them as being regardless of OS and the like.

Since it is composed as described above, it is not depending on machine types and therefore no expert operators are need on the client side. Thus, the cost for maintenance and operation can be reduced. Moreover, when the programs for business works are renewed to upper versions and so on, the changes is made only with the main server, so that the labor and cost for maintenance and operation on the user side would be reduced.

Next, in another aspect of the business work administration support system, the aforementioned programs for business work processing include account processing programs usable to a plurality of currencies. Accordingly, a user can prepare or make various kinds of bills in different currencies when the user does works related financial and account processing of many types business works, so that the business works can be processed as accommodating with the internationalization.

In a further aspect of the business work administration support system, the aforementioned programs for business works include programs which accommodate with a plurality of languages and bill formats employed by nations using these languages as their mother tongues. If such a system is used, various kinds of bills that a user has to issue can be prepared in a mother tongue of each nation and in a format as following to business customs of the nation. Thus, the business works can be processed as accommodating with the internationalization.

Moreover, in an other aspect of the present invention, the main server can include two separate servers. One is a database server to store the data and the other is a business work processing server holding the programs for business works.

In addition, when the client machine and main server communicate each other, the main server must be protected with security technologies. In regard to the security technologies, conventional cryptographic technology, fire wall or so are used. Moreover, it is also possible to provide a security server between the main server and the client machine in order to judge whether the identification data sent from the client machine is true or not and then to allow the client machine and main server to communicate each other only when the identification data is judged as true. If such a system is employed, the security performance of the client machine and main server (database server and business work processing server) can be enhanced.

### BRIEF DESCRIPTION OF THE DRAWINGS

FIG. 1 is a diagram showing a structure of a first embodiment according to the present invention.

FIG. 2 is a diagram showing a structure of a second embodiment according to the present invention.

FIG. 3 is a diagram showing an example of conventional structures.

### DESCRIPTION OF THE PREFERRED EMBODIMENT

Now, the present invention will be described in detail by way of an embodiment with accompanying drawings.

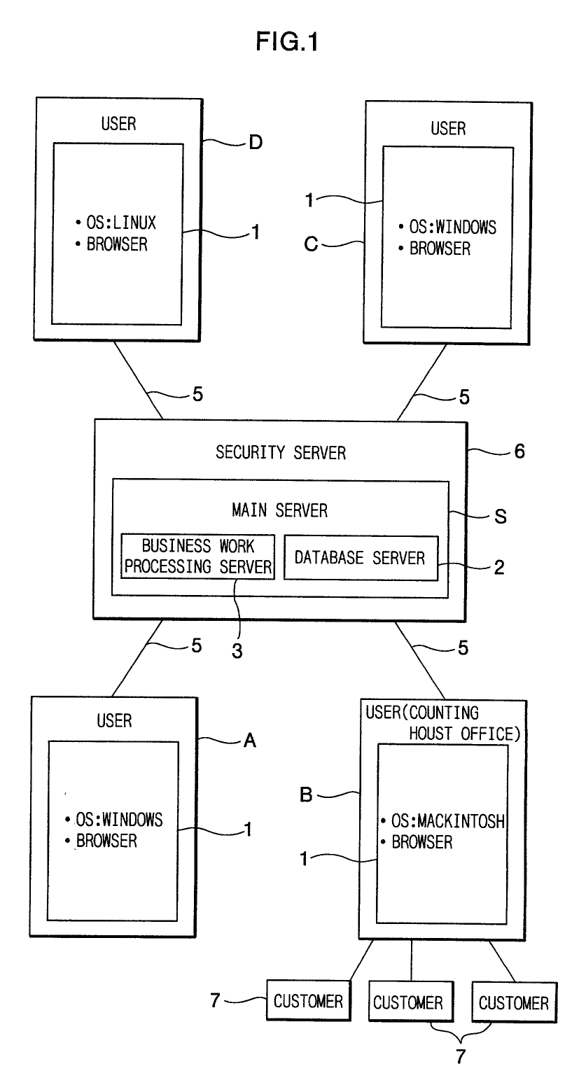

FIG. 1 shows a first embodiment of the present invention.

A business work administration support system related to this embodiment executes all or a part of business works of users A, B, C and D, for the users who own client machines 1. Such business work administration support system comprises client machines 1 owned by a plurality of users A, B, C and D, respectively, a main server S including one unit of database server 2 and one unit of business work processing server 3, and a communication network 5 for connecting the client machines and the main server. The database server 2 and business work processing server 3 constitute a main server S. It is a matter of course that the main server S can be composed into one unit instead of separate units as shown in FIG. 1.

The database server 2 included in the main server S stores data sent by the client machine 1 and necessary for business work processing. On the other hand, the business work processing server 3 memorizes various programs for business works for executing the business work processing. These programs for business work are renewed to the latest versions at need by a full time engineer staying at a central facility and the like where the main server S is installed in.

Moreover, a security server 6 is provided between the main server S consisting of the database server 2 and the business work processing server 3 and the communication network 5 to be connected to the client machines 1. The security server 6 judges whether the identification data sent from the client machine 1 is true or not. The security server 6 allows the client machine 1 and main server S to communicate each other only when the identification data is judged as true. By providing the security server 6, the security performance of client machine 1 and main server S (database server 2 and business work processing server 3) can be improved.

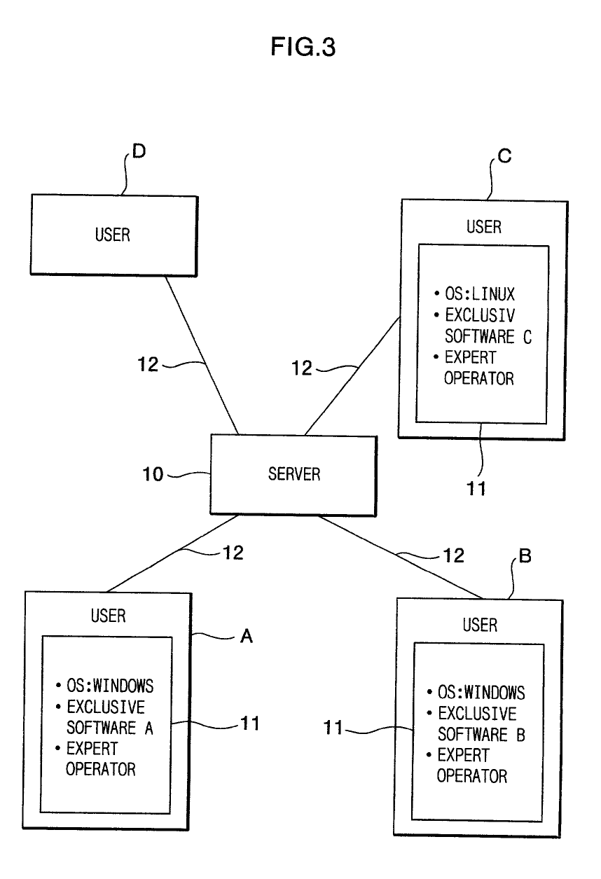

Here, ISDN (Integrated Services Digital Network) and a router (not shown) are employed for the communication network 5 in the same way as the system shown in FIG. 3. The main server S and client machine 1 are connected through the internet.

In case of this embodiment, the programs for business work processing, such as a program for account processing, stored in the business work processing server 3 are prepared in a JAVA language, in other words, these are JAVA applets. This JAVA language corresponds to the architecture neutral program language stated in Claims. The architecture neutral program language is a program language that can function without depending on OS, hardware and the like (and it is a matter of course that the program does not have to be translated). As the account processing program is prepared in the JAVA language, the database server 2, business work processing server 3 and client machine employ machines called JAVA virtual machines. These JAVA virtual machines correspond to the design made to support the program language. Since the programs for business works that are the JAVA applets do not have a particular characteristic in the present invention, the detail description is omitted thereof.

Furthermore, the client machine 1 is equipped with a browser that allows to use the programs for business works (that can indicate the process and result of works done by the programs).

When a user let the main server S execute his/her business works, such as account processing and the like, using a business work administration support system related to the present invention as mentioned above, it functions as follows. First, a client machine 1 at users A, B, C and D sends identification data (user's ID, password, authentication data and etc.) provided for the users A, B, C and D to the business work processing server 3 forming a part of the main server S. A security server 6 receives the identification data and then judges whether the received identification data is true or not. The security server 6 allows communication between the client machine 1 and main server S when it recognizes the identification data as true. On the other hand, if it recognizes the received identification data as false, it demands to input identification data up to a predetermined times (for example, twice). In case that the true identification data cannot be obtained within the predetermined times, the security server 6 recognizes the access as false and shuts down the communication.

When the security server 6 recognizes the identification data as true, it allows the client machine 1 to access the business work processing server 3 and the database server 2 as described above. That is to say, the client machine 1 is connected to the business work processing server 3 and the database server 2. In this situation, the client machine 1 sends the business work processing server 3 a command to execute a certain business work (such as an account processing work). The users A, B, C and D also send the database server 2 the necessary data to execute the required business works (for example, sales data, expenditure data and etc.).

Upon the input of the command, the business work processing server 3 selects programs for business works (for example, an account processing program) suitable to business work processing required by the user A, B, C or D and then executes the business work processing using data that has been sent from the users A, B, C or D and stored in the database server 2.

The client machine 1 is equipped with a browser that allows to use the program for business works (that can indicate the process and result of works done by the programs). Therefore, the process (middle of procedure) and result of works executed by the business work processing server 3 can be observed. Furthermore, the result can be outputted (for example, printing) and the output can be utilized.

In the business work administration support system related to this embodiment, the programs for business works are prepared in the JAVA language as described above. The database server 2, business work processing server 3 and client machine 1 are JAVA virtual machines designed to support the JAVA language. Thus, the business work administration support system becomes independent from machine types. As a result, the users A, B, C and D do not need to have expert operators for maintenance and operation.

Furthermore, any machine types can be employed for the client machine 1. Any types of machines corresponding to the virtual JAVA machines equipped with the browser can be used as a client machine 1, so that even small old model computers can be used. Moreover, the users A, B, C and D and the main server S are connected by the internet as described above and therefore the users can make the main server S to execute their business works without having any special devices, even if branches and offices happen to locate in many different places. In addition, since the main server S is intensively taken care at its location, the maintenance and operation by the users A, B, C and D are not necessary and the cost can be reduced.

Unlike the aforementioned conventional system, the main server S utilized in the business work administration support system related to this embodiment is not installed at user's offices and the like, such as a counting house who would support the business works. The main server S is installed at any location, such as a central facility. Companies, counting houses and others who have to perform accounting works can access to the main server S to let it to execute business works whenever necessary. For example, the user B shown in FIG. 1 represents an office of counting house. The user B, an accountant, is entrusted to do accounting works by many clients 7. Such an office of counting house is provided with the client machine 1 and the user can let the main server S to execute (the all or a part of) accounting works of each of clients 7 through the client machine 1 in the office. Thus, in this embodiment, users who have clients, such as a counting house, are able to let the main server to execute entrusted business works. Unlike the aforementioned conventional system, a user who is entrusted to execute business works does not need to install a server 10 (FIG. 3) in office but simply install the client machine 1, so that the professional fees relating to the entrusted business works can be set less expensive. The above structure may is applied to a following second embodiment in common.

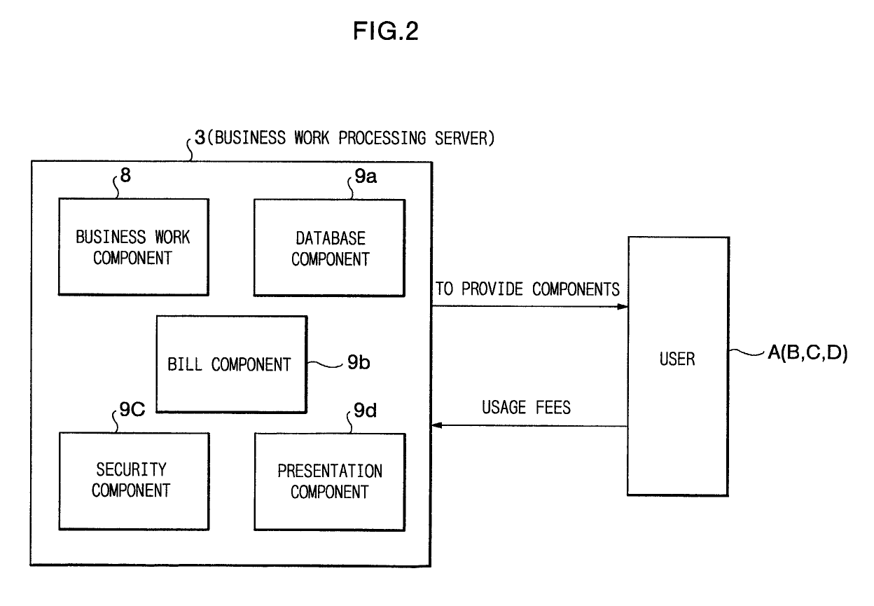

Next, FIG. 2 shows a second embodiment of the present invention related to a business work administration support system. In the same manner as the aforementioned first embodiment, a business work administration support system related to this embodiment comprises the client machines 1 owned by the users A, B, C and D and the main server S and the communication network 5 for connecting the client machines and the main server. The communication network is one, such as the internet using ISDN, as shown in FIG. 1. Among components comprising programs for business works stored in the main server S, only components necessary to execute desirable business works can be downloaded into a plurality of client machines 1 (see FIG. 1) owned by users A, B, C and D in order to execute desirable business works.

The main server S in this embodiment comprises one unit of database server 2 and one unit of business work processing server 3. The database server 2 forming a part of said main server S stores data necessary for the users A, B, C and D having the client machines 1 to execute various kinds of business works, such as accounting, salary calculation, sales management, stock and distribution management and so on. In addition, the main server S may be composed of one unit, instead of separate units as shown in FIG. 1.

On the other hand, the business work processing server 3 holds components comprising various kinds of programs for business works that enable to execute required business works. That is, as shown in FIG. 2, various kinds of programs for business works in the business work processing server 3 are stored component by component. These various kinds of programs for business works (components) are updated to the latest versions as need by a full time engineer and the like who is staying at an office and the like where the main server S is installed in.

Furthermore, among components 8 comprising various kinds of programs for business works, there is a component 8 for executing business works related to finance and accounting. The programs for business works related to finance and accounting are able to deal with a plurality of currencies, such as yen, dollar, euro, mark, franc and etc. That is, it can execute business works relating to the accounting not only in the national currency yen but also in dollar and euro. In addition, the programs for business works relating to finance and accounting include a program (or a component 8 comprising the program) for yen to dollar conversion.

At the same time, in the system relating to this embodiment, a program for business works (or a component 8 comprising the program) stored in the business work processing server 3 has a function for preparing the bills in a plurality of languages, such as English, French, German and others in addition to Japanese. It also include a program (or a component 8 comprising the program) that can accommodate to bill formats employed by countries using the various languages for their mother tongues (US, France, Germany and others) as well as bill formats based upon the International Accounting Standards (IAS).

In addition to the program accommodating to various bill formats (bill component 9b comprising the program), the business work processing server 3 further includes not only a lot of components 8 constructing programs for business works to execute the various kinds of business works (only one component 8 is shown in the FIG. 2), but also many kinds of components related to the business works, such as a database component 9a, a security component 9c and a presentation component 9d and the like. Here, each of these components 8, 9a, 9b, 9c, and 9d can be freely provided to the client machines 1 owned by the uses A, B, C and D.

Furthermore, a security server 6 is provided between the communication network connected to the client machine 1 and the main server S consisting of the database server 2 and business work processing server 3. The security server 6 judges whether the identification data sent from the client machine is true or not and then the security server 6 allows the client machine 1 and main server S to communicate each other only when the identification data is judged as true. Therefore, by providing the security server 6, the security performance of client machine 1 and main server S (including database server 2 and business work processing server 3) can be largely enhanced. A part of the security component 9c is necessary when the security server 6 is used.

In case of this embodiment, programs (many kinds of components 8 comprising the programs) for business works, such as an account processing program, stored in the business work processing server 3 as well as other components 9a, 9b, 9c and 9d are prepared in a JAVA language. In other words, these are JAVA applets. The JAVA language corresponds to the architecture neutral program language. As an account processing program is prepared in the JAVA language, the database server 2, business work processing server 3 and client machine 1 employ JAVA virtual machines. These virtual machines are designed to support the program language.

When users A, B, C and D perform account processing works using the business work administration support system relating to this embodiment, it functions as follows. First, client machines 1 at the users A, B, C and D send identification data (user's ID, password, authentication data and etc.) provided with the users A, B, C and D to the security server 6. The security server 6 receives the identification data and then judges whether the received identification data is true or not. The security server 6 allows the communication between the client machine 1 and main server S when it recognizes the identification data as true. On the other hand, if the received identification data is recognized as false, it demands to input the identification data up to a predetermined times (for example, twice). In case that the true identification data cannot be obtained within the predetermined times, the security server 6 recognizes the access as false and shuts down the communication.

When the security server 6 recognizes the identification data as true, it allows the client machine 1 to access the business work processing server 3 and the database server 2 as described above. That is, the client machine 1 is connected to the business work processing server 3 and the database server 2. In this situation, the users A, B, C and D can download components 8 necessary for business works required by each of the users A, B, C and D out of programs for business works (components 8) stored in the business work processing server 3, in order to perform business works required by each of the users A, B, C and D at the side of the client machines.

In the system relating to this embodiment, the programs for business works are stored in the business work processing server 3 component by component. Thus each of the users A, B, C and D downloads components 8 necessary to execute his/her business works and combines these downloaded components 8s for his/her use. Therefore, it can prevent waste of memory areas of memory unit, such as a hard disk, prepared in the client machine 1. At the same time, business works required to perform by the users, such as accounting, sales reports, salary calculation and stock and distribution management, can be easily executed. Furthermore, in this embodiment, the quality of programs are expected to be uniform and improved because the programs for business works are provided in a form of components. The maintenance becomes easy as well.

Moreover, in the business administration support system relating to this embodiment, the components 8, 9a, 9b, 9c and 9d corresponding to the programs for business works (components 8 and the like) are prepared in the JAVA language as described above and the database server 2, business work processing server 3 and client machine 1 are JAVA virtual machines designed to support the JAVA language. Thus, the business work administration support system becomes independent in terms of machine types. As a result, the users A, B, C and D become no longer necessary to have expert workers for maintenance and operation.

Furthermore, the client machines 1 are free from machine types. Any types of machines that are corresponding to the virtual JAVA machines and equipped with the browser can be used as a client machine 1, so that even small old model computers can be used. Moreover, the users A, B, C and D and the main server S are connected by the internet as described above and therefore the users can make the main server S to execute their business works without having any special devices, even if branches and offices happen to locate in many different places. Also, since the main server S are intensively taken care at its location, the maintenance and operation by the users A, B, C and D are not necessary and therefore the cost can be reduced.

In addition, in the business work administration support system relating to this embodiment, the programs for business works include an account processing program (component 8) that can accommodate to many different currencies, so that, in regard to works concerning finance and accounting among many business works, the users can prepare various kinds of bills in variety of currencies used by many different nations, therefore, it enables to perform business work administration as matching with the internationalization movement.

Furthermore, programs for business works relating to this embodiment include programs accommodating to many languages as well as bill formats employed by nations that use these language as their mother tongues, so that bills that are to be prepared by users can be made or produced in variety of languages as well as formats in accordance with business customs of each nation (or in formats based upon the International Accounting Standards). Therefore, it enables to meet with the internationalization movement.

Here, the client machine 1 is equipped with a browser that allows to use the programs for business works (that can indicate the process and result of works done by the programs). This browser enable to observe the process (middle procedure) and result of works executed by the business work processing server 3. Furthermore, the result can be outputted (for example, print) to use it.

When the users A, B, C and D download each of said components 8, 9a, 9b, 9c and 9d , the users A, B, C and D are charged with fees in accordance with the number of components 8, 9a, 9b, 9c and 9d that the users have downloaded. The fees charged in accordance with uses of each of components 8, 9a, 9b, 9c and 9d shall be paid by a bank transfer, credit card or electric transaction system.

In the first embodiment, since the business work administration support system has the structures and functions as described above, it are free from machine types, requires no expert operators, enables to reduce labor and cost for maintenance and operation and allows the users to execute the business work administration in the latest style all the time. As a result, the business works can be performed promptly at low cost. Thus, it is very effective in industrial utilization.

In the second embodiment, the programs for business works are made in the form of components, and these components can be provided one by one. Thus, a common portion among these components can be used in repeatable during development of programs and the cost for development can be reduced. Moreover, the quality of these various programs can be uniform and be improved as these are made into the form of components.

In addition to the above effects, the business work administration support system of another aspect of the present invention allows the users to prepare various kinds of bills in many different currencies used by many different nations when they execute business works relating to finance and accounting. Therefore, the business works can be processed as meeting with the internationalization movement.

In addition to the above effects, the business work administration support system of the other aspect of the present invention allows the users to prepare their bills in variety of languages and formats in accordance with business customs and the like of many different nations. Therefore, it enables to meet with the internationalization movement.

1. A business work administration support system including at least one client machine, at least one main server and a communication network for connecting said client machine and said main server, said business work administration support system processing all or a part of business works of a user who owns the client machine for the user,
wherein the main server can readily store data necessary for business work processing sent from the client machine and stores program for business works to perform the business work processing,
wherein the client machine is equipped with a browser to indicate a business work process and a result thereof, and
wherein the programs for business works stored in the main server are prepared in an architecture neutral program language, and the client machine and said main server are designed to support the program language.

2. A business work administration support system including at least one client machine, at least one main server that stores data necessary for processing various types of business works as well as contains components constituting programs for business works for executing various types of business works, and a communication network for connecting said client machine and said main server,
wherein a user who owns the client machine is able to readily download one of said components necessary to execute business works into the client machine, and
wherein the programs for business works stored in the main server are prepared in an architecture neutral program language, and the client machine and said main server are designed to support the program language.

3. A business work administration support system according to claim 2,
wherein said programs for business works include an account processing program accommodating with a plurality of currencies.

4. A business work administration support system according to claim 2,
wherein said programs for business works include programs accommodating with a plurality of languages as well as bill formats employed by nations using these languages as their mother tongues.

5. A business work administration support system according to claim 1,
wherein said main server comprises a database server for storing the data and a business work processing server for storing the programs for business works.

6. A business work administration support system according to claim 2,
wherein said main server comprises a database server for storing the data and a business work processing server for storing the programs for business works.

7. A business work administration support system according to claim 1, further comprising a security server between said main server and said client machine in order to judge whether the identification data sent from the client machine is true or not and then to allow said client machine and said main server to communicate each other only when the identification data is judged as true.

8. A business work administration support system according to claim 2, further comprising a security server between said main server and said client machine in order to judge whether the identification data sent from the client machine is true or not and then to allow said client machine and said main server to communicate each other only when the identification data is judged as true.
